(19) United States
(12) Patent Application Publication
(10) Pub. No.: US 2005/0140818 A1
(43) Pub. Date: Jun. 30, 2005

(54) Camera module and portable terminal equipped with the camera module

(75) Inventors: Kouhei Uemura, Takatsu-ku (JP); Katsumi Tsuji, Yokohama-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORAION

(21) Appl. No.: 11/023,047

(22) Filed: Dec. 27, 2004

(30) Foreign Application Priority Data
Dec. 26, 2003 (JP) 2003-435372
Dec. 26, 2003 (JP) 2003-435599
Jan. 30, 2004 (JP) 2004-24631
Jan. 30, 2004 (JP) 2004-24633

(51) Int. Cl. H04N 5/225

(52) U.S. Cl. 348/360

(57) ABSTRACT

The casing of the camera module is composed of at least two housings. In the opening part of the first housing for attaching the object side fixed lens is formed an annular formation extending radially inwardly to support the fixed lens. The annular formation has protruded portions protruding inwardly. A lens moving mechanism including a cylindrical cam and moving lens holders are incorporated in the casing. The lens holders each has a cam follower arm which contact the corresponding cam face of the cylindrical cam, the movement of each of the lens holders being defined by the cam face, and supporting arms fitted slidably to guide shafts for guiding the lens holders in the direction of the optical axis. One of the lens holders has depressed portions to correspond to the protruded portions of the annular formation in order to allow the lens holder to advance into the space surrounded by the annular formation without interfering with the protruded portions of the annular formation whereby the lens holder can come near to the fixed lens. A driving motor for rotating the cylindrical cam is bonded to the second housing. The casing defines a plurality of openings to be covered after assembling. Assembling and adjustment of the lens moving mechanism, etc. can be performed with ease. A small and lightweight camera module can be constructed, and a user-friendly portable terminal equipped with the camera module can be provided.

### FIELD OF THE INVENTION

1. Field of the Invention

The present invention relates to a camera module and a portable terminal provided with the camera module.

2. Description of the Related Art

A camera module having the function of autofocusing (AF) and/or zooming used for a portable terminal such as a mobile telephone is required to be constructed small in size.

When a camera module having an autofocusing (AF) function or zooming function is reduced in size, zoom lenses also must be downsized. However, the zoom lenses must me moved in the direction of the optical axis of the lenses in order to change the focal distance thereof. Therefore, it is necessary to downsize the lenses, to secure as long traveling distance of lenses as possible in a small space, and to downsize lens holders for retaining lenses, moving mechanism or driving mechanism thereof. A variety of devisal are required to downsize the camera module while keeping easiness of assembling and adjusting.

As a camera module like this, there is disclosed a camera for example in JP 7-63970(hereafter referred to as patent literature 1), in which a cylindrical cam located at the side of the optical system of the camera is driven by a motor to move a lens holder for zooming and a lens holder for focusing. In JP 2003-258971 (hereafter referred to as patent literature 2) is disclosed a camera module with zooming function for integrated into a mobile telephone, which is composed such that a lens holder for zooming and a lens holder for focusing are driven by rotating by hand a cylindrical cam partially exposing outside of the mobile telephone at the side face of the portion where optical system is accommodated.

In JP 5-84912 (hereafter referred to as patent literature 3) is disclosed a camera, which is composed such that a pinion gear for moving a zoom lens barrel is accommodated in a cut-out part of the cylindrical part for accommodating the lens barrel, as a result the driving mechanism of the zoom lens barrel is accommodated in a small space with the driving mechanism attached to a light shielding plate. In JP 5-333254 (hereafter referred to as patent literature 4) is disclosed a lens moving device used for a video camera, etc. for moving the lens stably, the device being provided with two guide receiving parts protruding from the periphery of a lens frame holding the circumference of the lens. In Japanese Laid-Open Patent Application No. 2-46413 (hereafter referred to as patent literature 5) is recited a lens barrel as an example of prior art, in which the barrel has a cutout opening part through which each lens frame can be rotated for eliminating deviation in optical axis of lenses.

Further, there are known a lens moving mechanism for utilizing the space of lens barrel efficiently, in which a supporting part of the guide of lens frames is provided in a housing retaining a subject side lens and lens frames for zooming and focusing are driven by means of two lead screws (hereafter referred to prior art 1); a lens moving mechanism for configuring the lens barrel in small size, in which are provided a lead screw for zooming in the first quadrant around the optical axis, a lead screw for focusing in the second quadrant, and a guide shaft for guiding lens frames (hereafter referred to prior art 2); and a lens moving mechanism in which a subject side lens is retained in a upper housing, lens frames for zooming and focusing are driven by two lead screws respectively, bearings for the two lead screws and two guide shafts of the lens frames are provided in the upper housing, and CCD is attached to a lower housing (hereafter referred to prior art 3).

Further, as a camera module, there are known one which is downsized by locating a lead screw for autofocusing and a lead screw for zooming on one side of the case and making it possible to assemble lenses from one side of the lens barrel of the camera module (hereafter referred to prior art 4); one in which switching between telephotographing and macro-photographing in pan-focus lenses is done by means of a cylindrical cam located in the vicinity of lens frames (hereafter referred to prior art 5); and one in which holders of optical pickup lenses used for video disc player, digital audio player, optical disc file, etc. are made of resin containing fluorine for reducing inertia force by lightening the weight of the holders as far as possible (hereafter referred to prior art 6). In an autofocusing type video camera, shafts of aluminum, etc. coated with fluororesin are used for improving sliding property and abrasion-resistant property (hereafter referred to prior art 7).

However, the device disclosed in patent literature 1 is related to a camera module for a video camera, gives no consideration to downsize it to be installed in a portable terminal, and a drive motor is located remote from the optical system in an ample space inside the camera module; the device disclosed in patent literature 2 is related to a small sized camera module to be integrated in a portable terminal, etc., but it is manual operation type and can not be applied to a camera module in which zooming and autofocusing are performed by means of a motor.

Patent literature 3 is related to a light shielding mechanism to make it possible to accommodate a zoom lens moving mechanism in a small space and does not teach a composition to secure enough travel distance of the zoom lens in a small space. Patent literature 4 relates to a lens moving mechanism for moving a lens used for a video camera, etc. stably, patent literature 5 relates to an aligning method of lenses, and each of these does not teach a composition to secure enough travel distance of the zoom lens in a small space.

According to prior art 1, the space of lens barrel is utilized efficiently, however, it is featured only in that the subject side lens is retained in the housing thereof and the supporting part of the lens frames is provided in the housing, a driving device such as a motor is not integrated, and it is difficult to find it informative for composing a camera module.

According to prior art 2, although the space around the optical axis is utilized efficiently by locating a lead screw for zooming, a lead screw for focusing, and a guide shaft for guiding lens frames around the optical axis, it is also difficult to find it informative for composing a camera module so that enough travel distance of zoom lens can be secured in a small space. According to prior art 4, although a lead screw for autofocusing and a lead screw for zooming are located at one side of the casing to downsize the camera module, it is difficult to reduce the size enough, for the lead screws are provided separately for autofocusing and zooming; and according to prior art 3, a driving mechanism and CCD are attached to separate housings and assembly process becomes complicated, so that they can not serve as a useful reference for composing a small sized camera module.

According to prior art 5, switching between telephotographing and macro-photographing is done by means of a cylindrical cam located in the vicinity of lens frames, this module is for pan-focusing and can not serve as a useful reference when autofocusing mechanism is to be installed.

Prior art 6 relates to a pickup lens holder for optical disc, is informative for reducing weight but can not serve as a useful reference from the point of view of downsizing a camera module.

In prior art 7, shafts made of aluminum must be coated with fluororesin, which results in an increased cost.

### SUMMARY OF THE INVENTION

The object of the present invention is to provide a camera module constructed such that a sufficient distance of lens movement is secured in a small space even if the function of autofocusing (AF) and/or zooming is incorporated, and a portable terminal equipped with the camera module.

To achieve the object mentioned above, the present invention proposes a camera module comprising accommodated in the casing thereof an optical lens system, a lens moving mechanism for moving a plurality of lenses of an optical lens system in a predetermined direction to perform focal adjustment and/or change of image magnification, and a housing composing a casing of the camera module,
a lens retaining part formed in said housing for retaining one of the lenses of the optical lens system,
lens holders for accommodating said moving lenses,
protruded portions provided in said lens retaining part for contacting said one of the lenses at least at three points to determine the position of said one of the lenses, and concaved portions provided in said protruded portions such that the peripheral part of said one of the lenses is exposed,
whereby at least one of said lens holders can advance to said concaved portions provided in said protruded portions.

Said at least one of lens holders has depressions (second concaved portions) to correspond to said protruded portions in said lens retaining part, and said lens moving mechanism includes a cylindrical cam located in the vicinity of the periphery of said lens holders, a cam bearing part for supporting said cylindrical cam, guide shafts for guiding said lens holders, and guide shaft attaching parts for attaching said guide shafts, and wherein said guide shaft attaching parts and said cam bearing part are formed in one piece with said housing.

Further, to achieve the object mentioned above, the present invention proposes a camera module comprising accommodated in a housing composing the casing thereof an optical lens system, a lens moving mechanism for moving a plurality of lenses of the optical lens system in a predetermined direction to perform focal adjustment and/or change of image magnification, wherein are provided lens holder or holders for retaining at least some of the lenses of the optical lens system, a cylindrical cam for moving the lens holder or holders in the direction of the optical axis, and guide shafts for guiding the lens holder or holders in the direction of the optical axis, and therein each of said lens holders has supporting arms extending radially outwardly to be fitted slidably to said guide shafts and a cam follower arm extending radially outwardly in different directions, the arms being formed in one piece with the lens holder, and wherein said cam follower arm extends radially outwardly such that the cam follower arm overlaps in the direction of the optical axis at least partially with at least one of the supporting arms extending in a radial outward direction.

It is preferable that said supporting arms and cam follower arm are formed in one piece with said lens holder.

Further, said lens moving mechanism includes at least a gear group fitted rotatably to shafts to transmit the driving force of the driving source to said cylindrical cam, and wherein at least a shaft to which the last gear among said gear group is fitted rotatably (last stage gear shaft) is made of resin and other shafts are made of metal and said last stage gear shaft is formed in one piece with said housing.

The camera module of the invention comprises an optical lens system, a housing for composing the casing of the camera module for retaining and positioning at least a part of the optical lenses of the optical lens system and at least a lens holder and a accommodating a lens moving mechanism, a cylindrical cam located in the vicinity of the periphery of the lens holder or holders and supported for rotation for moving the lens holder or holders in the direction of the optical axis, a driving source, a last gear for driving the cylindrical cam, a gear or gears located between the last gear and the driving source, a shaft made of resin for fitting the last gear for rotation, shaft or shafts for fitting the gear or gears for rotation, and a supporting portion for supporting the shaft or shafts.

Further, the camera module of the invention comprises a housing composing the casing of the camera module, an optical lens system, a lens retaining part for retaining at least a part of the lenses of the optical lens system, a lens holder or holders for retaining moving lenses, a cylindrical cam located in the vicinity of the periphery of the lens holder or holders and supported for rotation for moving the lens holder or holders in the direction of the optical axis, cam bearing parts for supporting the cylindrical cam, gears for transmitting driving force of the driving source to the cylindrical cam, shafts for fitting the gears for rotation, a supporting part supporting the shafts, a lens retaining part for retaining and positioning at least an object side lens positioned nearest to the object of shooting; and the cam bearing parts, the shaft supporting part, and the lens retaining part are formed in one piece with the housing and the housing is made of resin. The cam bearing part is located in the vicinity of the lens retaining part and the shaft supporting part is located between the cam bearing part and the driving source.

Further, the camera module of the invention comprises an optical lens system, a housing composing the casing of the camera module and accommodating a moving mechanism and an image pickup device, a lens retaining part formed in one piece with the housing for retaining a part of lenses of the optical lens system, a mounting part provided in the housing for mounting the image pickup device, a lens holder or holders for retaining moving lenses of the optical lens system, guide shafts for guiding the lens holder or holders, supporting arms provided to each of the lens holders to be fitted to the guide shafts for sliding, a cam follower arm provided to each of the lens holders, a cylindrical cam to which the cam follower arm contacts for the lens holder to be moved; and the supporting arms and the cam follower arm are formed to extend radially in relation to the center of the lens holder, i.e. the optical axis with a certain angle such that at least one of the supporting arms overlaps at least partially with the cam follower arm. It is preferable that the supporting arms and the cam follower arm are formed in one piece with the lens holder. The bearing part for supporting the cylindrical cam and the supporting part of the guide shafts are formed in one piece with the housing. Further, the bearing part for supporting the cylindrical cam and the supporting part of the guide shafts are located near marginal parts inside the housing and gears for transmitting the driving force of the driving source are arranged between the driving source for driving the cylindrical cam and the cylindrical cam.

Further, in the camera module of the present invention, a positioning part is provided in said housing for locating said driving source to be fixed there, the positioning part having an opening part, and said gear group is arranged in the space near toward the part where said one of the lenses is located between said cylindrical cam and said driving source.

In the preferred embodiment of the invention, said housing is made of resin containing fluorine, and said cylindrical cam is made of resin.

To achieve the object mentioned above, the present invention proposes a portable terminal-having a camera module which comprises: a housing accommodating an optical lens system, a lens moving mechanism for moving at least some of the lenses of the lens system, and an image pickup device and composing the casing of a camera module, a lens retaining part formed integrally in the housing for retaining one of the lenses of the lens system, a attaching part provided in said housing for attaching said image pickup device, lens holders for retaining the lenses composing said optical lens system, protruded portions provided in said lens retaining part for contacting said one of the lenses at least at three points to determine the position of said one of the lenses, concaved portions provided in said protruded portions such that the peripheral part of said one of the lenses is exposed, guide shafts for guiding said lens holders, supporting arms provided to each of said lens holders for fitting rotatably to said guide shafts, a cam follower arm provided to each of said lens holders, a cylindrical cam contacting to said cam follower arms to allow the lens holders to be moved, whereby one of said lens holders can advance to said concaved portions provided in said protruded portions, wherein at least one of said supporting arms and said cam follower arm extending radially in different directions different by a certain angles from each other, and wherein said cam follower arm overlaps with at least one of the supporting arms in the direction of the optical axis; a case body equipped with the camera module; and an operating portion provided to said case body to operate said camera module mounted to said case body.

### BRIEF DESCRIPTION OF THE DRAWINGS

FIG. 1 is a perspective view of an embodiment of the camera module according to the present invention.

FIG. 2 is a perspective view of the first housing of the casing of the embodiment of the camera module according to the present invention.

FIG. 3 is a plan view of the first housing of FIG. 2.

FIG. 4 is a perspective view showing the state when guide shafts and gear shafts are being attached to the first housing of FIG. 2.

FIG. 5 is a perspective view showing the state when gears are being fitted rotatably to the gear shafts shown in FIG. 4.

FIG. 6 is a perspective view showing the state when gears have been fitted rotatably to the gear shafts shown in FIG. 4.

FIG. 7 is a perspective view of moving the lens assemblies and cylindrical cam of the camera module according to the present invention.

FIG. 8 is a perspective view showing when the moving lens assemblies and cylindrical cam of FIG. 7 are attached to the first housing.

FIG. 9A is a top view of one of lens holders, and FIG. 9B is a bottom view of the lens holder.

FIG. 10 a perspective view showing the state when the lens holder of FIG. 9A is mounted to the first housing.

FIG. 11 is a perspective view of the second housing together with the drive motor to be fixed to the second housing and the flexible band attached with an optical sensor and attached to the drive motor.

FIG. 12 is a perspective view of the second housing showing the state when the drive motor is fixed thereto facing to the cut-out opening part thereof.

FIG. 13 is a perspective view of the second housing showing the state when the drive motor is fixed thereto facing to the cut-out opening part thereof together with the flexible band attached to the drive motor.

FIG. 14 is a perspective view of the camera module before the CCD is attached for explaining attaching thereof.

FIG. 15 is a schematic view of the portable terminal installed with the camera module according to the present invention.

### DETAILED DESCRIPTION OF THE PREFERRED EMBODIMENTS

A preferred embodiment of the present invention will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

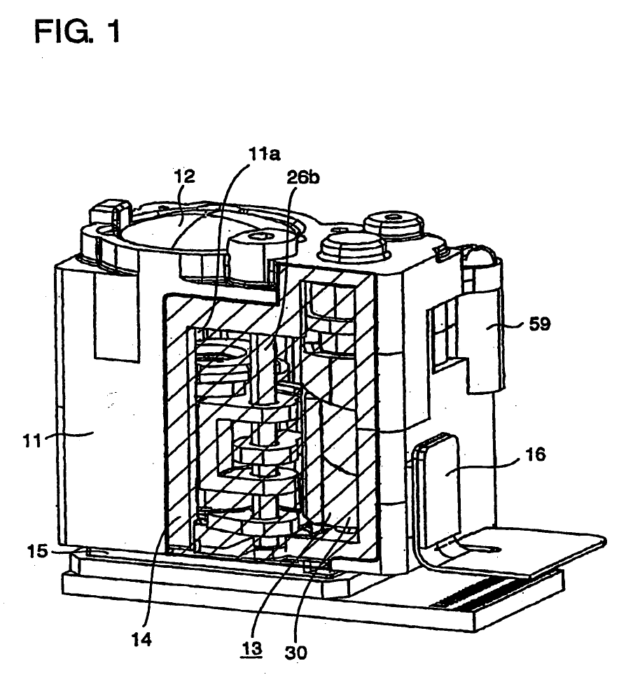

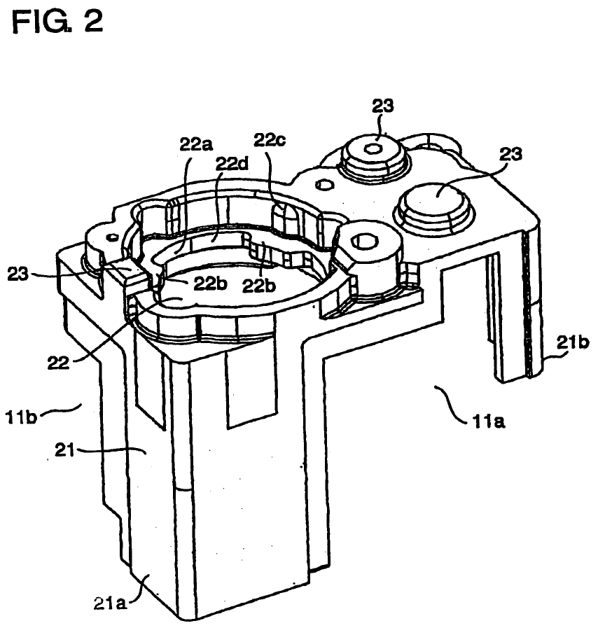

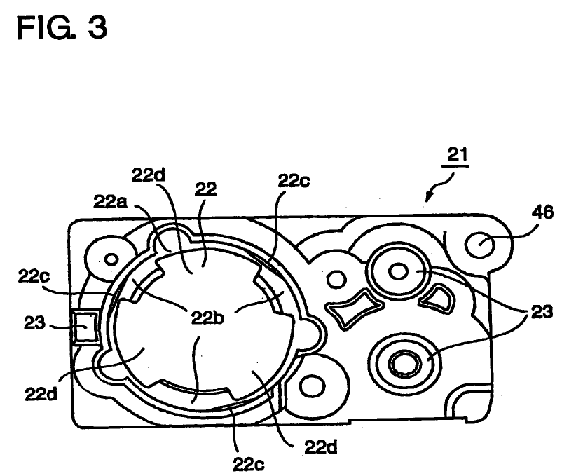

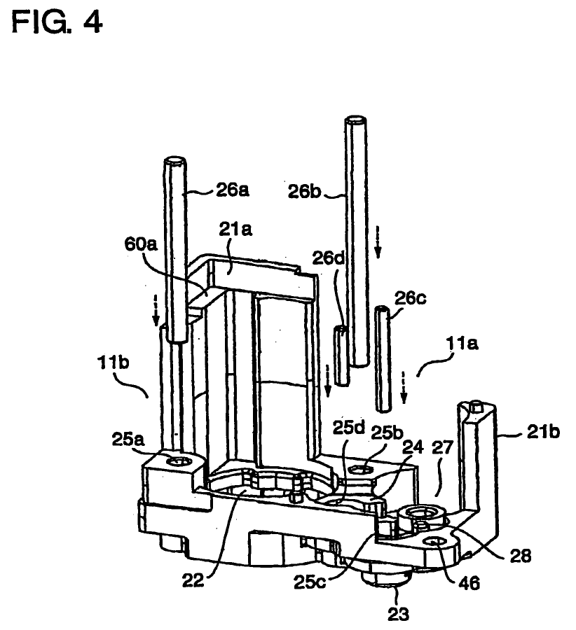

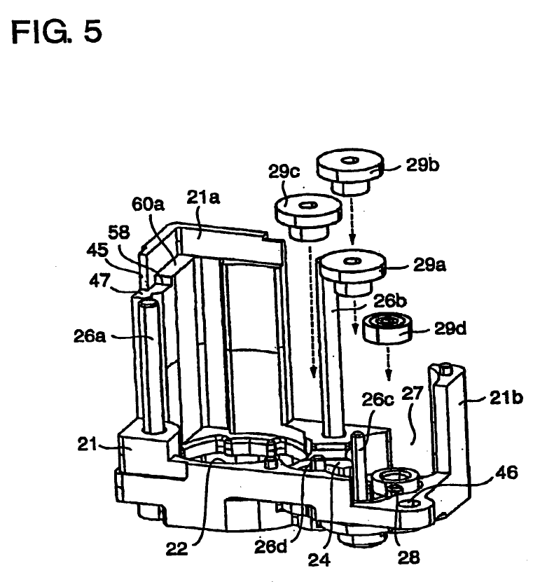

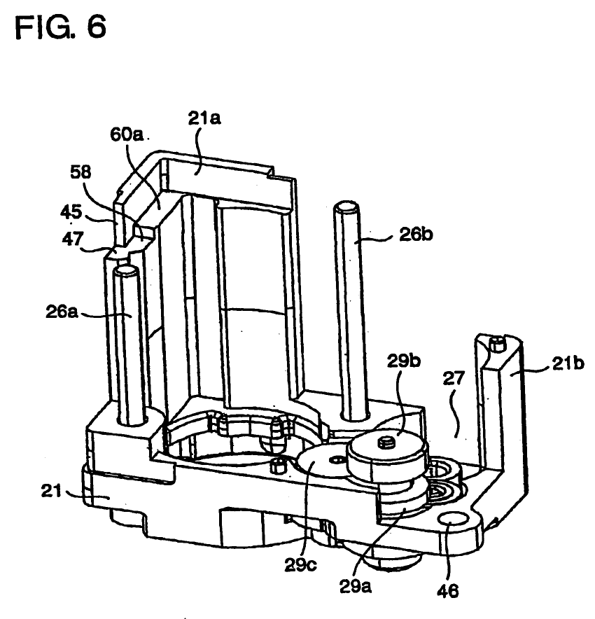

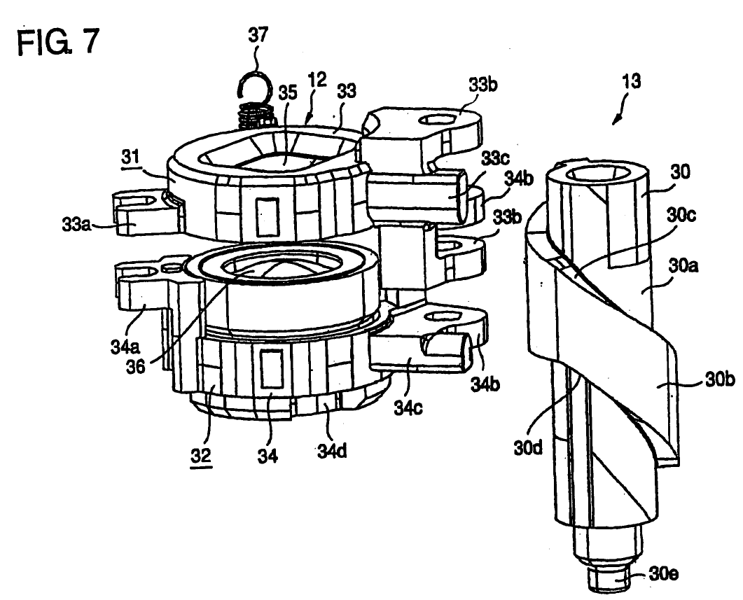

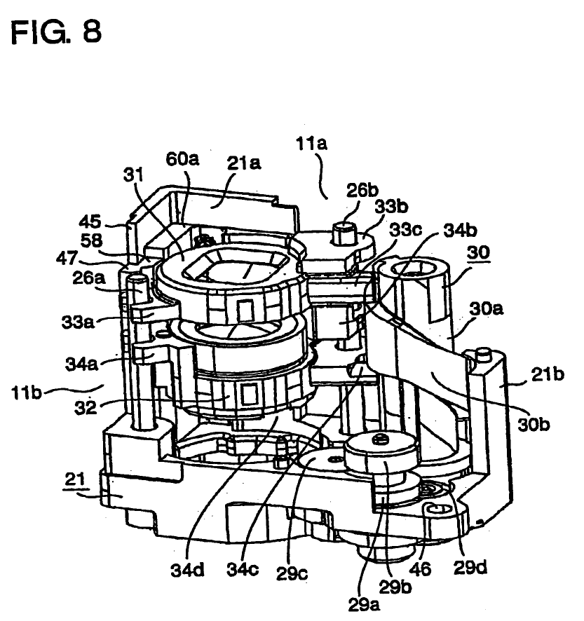

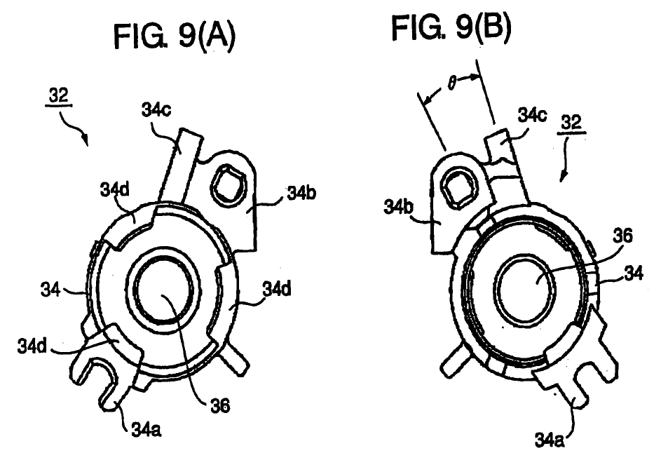

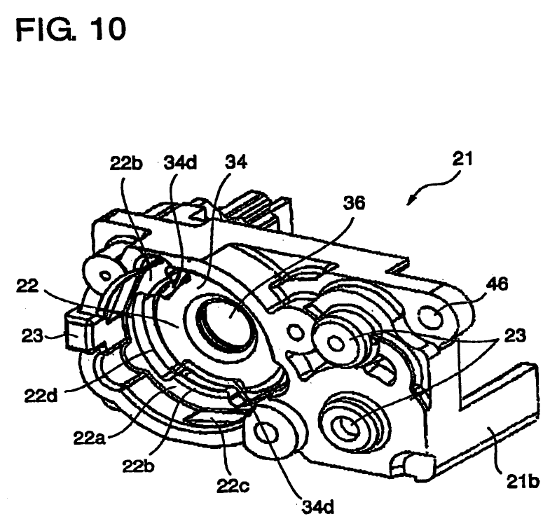

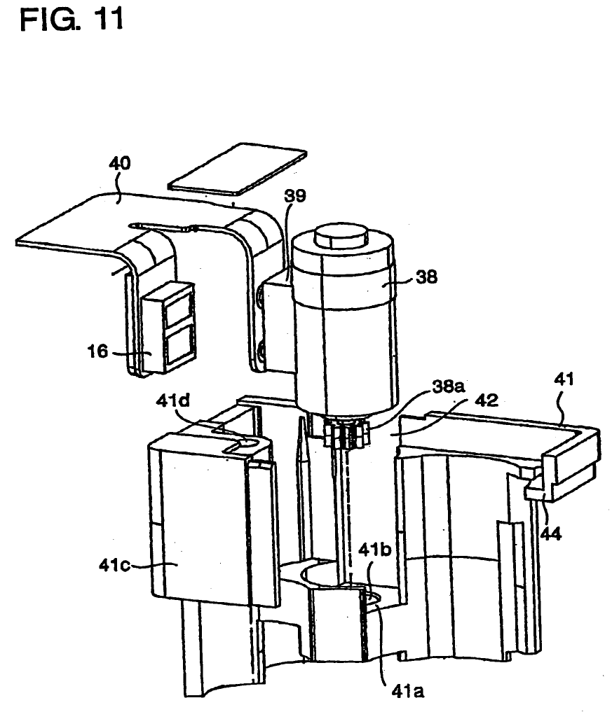

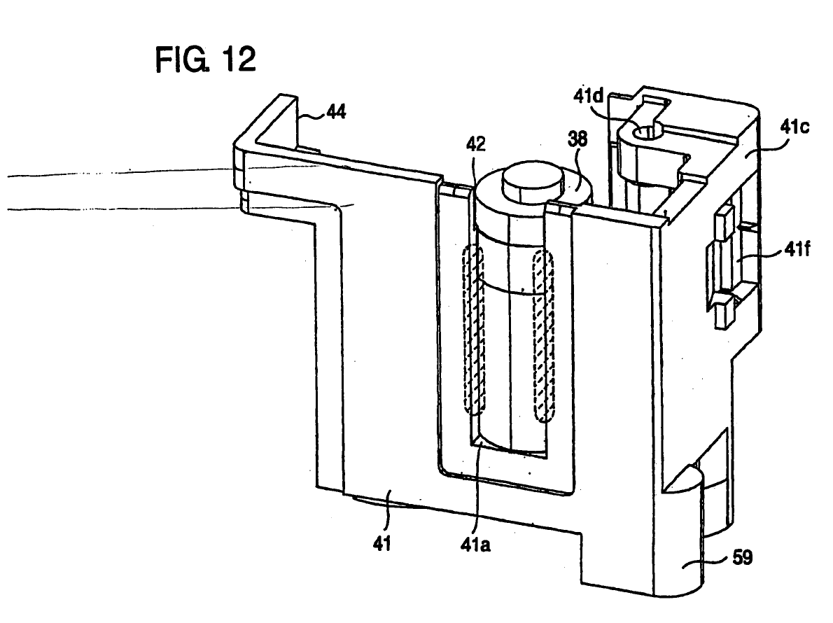

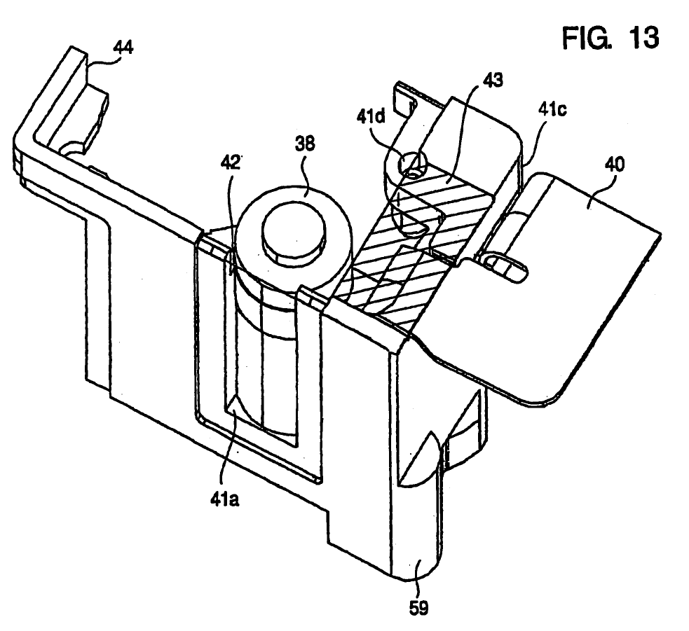

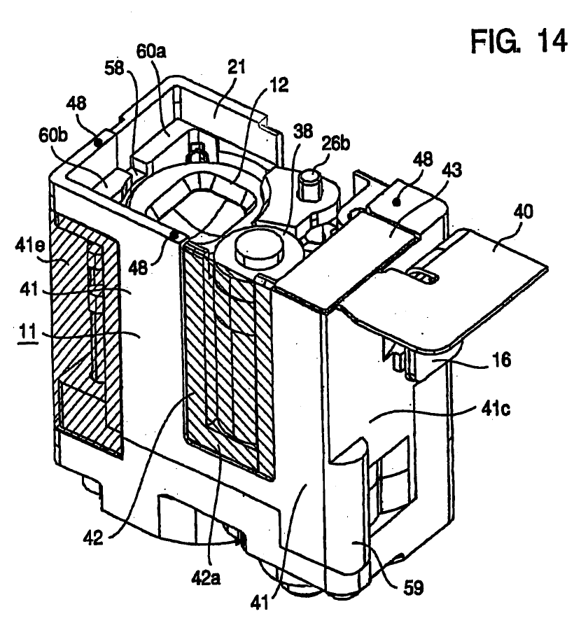

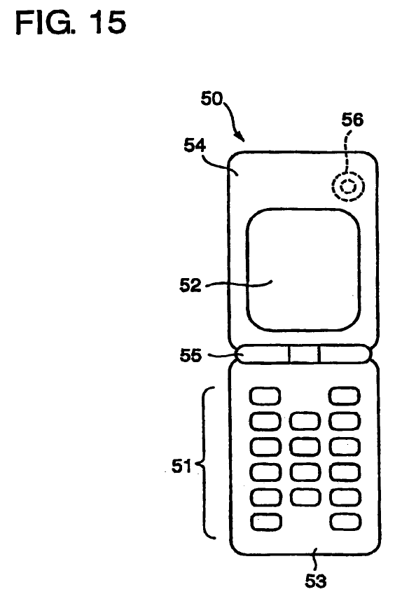

FIG. 1 is a perspective view of an embodiment of the camera module according to the present invention, FIG. 2 is a perspective view of the first housing of the casing of the embodiment of the camera module according to the present invention, FIG. 3 is a plan view of the first housing of FIG. 2, FIG. 4 is a perspective view showing the state when guide shafts and gear shafts are being attached to the first housing of FIG. 2, FIG. 5 is a perspective view showing the state when gears are being fitted rotatably to the gear shafts shown in FIG. 4, FIG. 6 is a perspective view showing the state when gears have been fitted rotatably to the gear shafts shown in FIG. 4, FIG. 7 is a perspective view of moving the lens assemblies and cylindrical cam of the camera module according to the present invention, FIG. 8 is a perspective view showing when the moving lens assemblies and cylindrical cam of FIG. 7 are attached to the first housing, FIG. 9A is a top view of one of lens holders and FIG. 9B is a bottom view of the lens holder, FIG. 10 a perspective view showing the state when the lens holder of FIG. 9A is mounted to the first housing, FIG. 11 is a perspective view of the second housing together with the drive motor to be fixed to the second housing and the flexible band attached with a optical sensor and attached to the drive motor, FIG. 12 is a perspective view of the second housing showing the state when the drive motor is fixed thereto facing to the cut-out opening part thereof, FIG. 13 is a perspective view of the second housing showing the state when the drive motor is fixed thereto facing to the cut-out opening part thereof together with the flexible band attached to the drive motor, FIG. 14 is a perspective view of the camera module before the CCD is attached for explaining attaching thereof, and FIG. 15 is a schematic view of the portable terminal installed with the camera module according to the present invention.

In the drawings, the same component is indicated by the same reference number. Referring to FIG. 1, reference numeral 11 is a camera casing (hereafter referred to simply as casing) made of, for example, polycarbonate containing fluorine, the casing 11 consisting of a first housing 21 (see FIG. 2) and a second housing 41 (see FIG. 11, 12). Reference numeral 12 is an optical lens system, 13 is a lens moving mechanism, 11a is an opening part of the casing 11, a hatched part indicated by reference numeral 14 is a cover plate (light shielding plate) covering the opening part 11a. Reference numeral 15 is a CCD which is attached to the casing 11 at the lower side thereof in the drawing and by the light received through the optical lens system 12 is converted to an electric signal. Reference numeral 16 is an optical sensor (light emitting device and photoreceptor device) attached to the side of the casing 11. The optical sensor 16 detects the rotation position or rotation angle or rotated angles of the cylindrical cam and the distance of the position of the moving lens group or groups from a reference position is calculated. The optical sensor 16 is attached to a flexible band 40 (see FIG. 11) which also serves as a covering plate to cover an opening 41f provided on a side wall 41c of the second housing 41.

Referring to FIG. 2, FIG. 3, and FIG. 10, reference numeral 21 is the first housing of the casing 11. A first thick side wall part 21a and a second thick side wall part 21b extend from the upper part (base part) of the first housing 21. Cutout opening parts 11a and 11b are defined between the thick side wall parts 21a and 21b. Reference numeral 22 is an opening formed in the base part (upper part in FIG. 2 of the first housing) for retaining the object side fixed lens of the optical lens system (not shown in FIG. 2) of the camera module, 22a is an annular formation extending radially inwardly from the inside surface of the opening 22, and 22b's are reference surfaces on a plurality of protruded portions protruding radially inwardly of the annular formation 22a, in the embodiment three protrusions being formed. Reference numerals 22c's are salient parts for positioning the object side fixed lens so that its center coincides with the center line of the optical lens system, 22d's are concaved portions of the annular formation 22a to allow a lens holder 34 (see FIG. 7) to advance into the space surrounded with the annular formation 22a, and 23's are reference surfaces, which serve as reference surfaces when assembling, on a plurality of protrusions provided on the outer face of the base part of the first housing 21, in the embodiment three protrusions being formed.

In FIG. 4 is shown the first housing of FIG. 2 in an upside-down position. In the drawing, reference numeral 24 is a mounting portion provided near the opening 22 to mount a lens moving mechanism (not shown in FIG. 4) to be mounted to the base part of the first housing 21. On the mounting portion 24 are formed a cam mounting part 27 for mounting a cylindrical cam mentioned later and a shaft body 28 protruding upward near the cam mounting part 27. Reference numerals 25a and 25b are a first and a second hole for fixing a first and a second shaft (guide shafts) respectively, the holes 25a and 25b being provided on the base part near the peripheral part of the opening 22 with angular spacing of about 180° to each other. Reference numerals 25c and 25d are a third and a fourth hole for fixing a third shaft and a fourth shaft respectively. Reference numerals 26a, 26b, 26c, and 26d are a first, a second, a third, and a fourth shaft made of, for example, stainless steel. Among them, the first and second shaft 26a and 26b are guide shafts for guiding moving lens groups (not shown in FIG. 4) of the optical lens system and inserted into the first and second hole 25a and 25b respectively to be fixed there. The third and fourth shaft are inserted into the third and fourth hole 25a and 25b respectively to be fixed there. Reference numeral 46 is a bolt hole for a screw bolt (not shown in the drawing) to fasten the first housing 21 and the second housing 41 (see FIGS. 11, 12).

Referring to FIG. 5, reference numerals 29a-29d are gears to be fitted rotatably to the third and fourth shaft 26c and 26d and to the shaft part 28 as indicated by arrows with broken lines. A first gear 29a is fitted rotatably to the third shaft 26c and then a second gear 29b is fitted rotatably to the same on the first gear 29a. A third gear 29c is fitted rotatably to the fourth shaft 26d and a fourth gear 29d is fitted rotatably to the shaft part 26. The second gear 29b meshes with the third gear 29c, the third gear 29c meshes with the first gear 29a, and the first gear 29a meshes with the fourth gear 29d (see FIG. 6). As mentioned later, the gear of a driving motor is allowed to mesh with the second gear 29b and the rotation driving force of the driving motor is transmitted to the cylindrical cam via the gears 29b, 29c, 29a, and 29d (See FIG. 8. In FIG. 6 and FIG. 8. The gear 29b is shown on the way of being fitted rotatably to the shaft 26c, the gear 29b will be pushed down until it meshes with the gear 29c.). Reference numeral 45 is a side end face of the side wall part 21a of the first housing 21, where a side end face 44 of the second housing 41 mentioned later is jointed, 47 is an adhesive-joining part for joining the first housing 21 with the second housing 41 with an adhesive agent, the joining part 45 being located at a corner opposing about diagonally to the bolt hole 46 of the first housing 21, 58 is a concave formed when the first housing 21 and second housing 41 are assemble and fixed to each other as shown in FIG. 14, the concave 58 serving as a well for retaining an adhesive agent for adhering a board mounted with the CCD 15.

FIG. 7, FIG. 8, and FIG. 9 show moving-lens assemblies and a cylindrical cam, the state they are assembled to the first housing, and a top and bottom view of a moving-lens holder respectively in a state the camera casing in FIG. 1, 2 is turned upside-down. In the drawings, reference numeral 30 is a cylindrical cam for driving a lens driving mechanism 13 assembled to the first housing 21. The cylindrical cam 30 has a cylindrical part 30a, a spiral formation 30b around the periphery, and a journal 30e at the lower end. On the spiral formation 30b are defined an upper spiral cam face 30c and a lower spiral cam face 30d. The upper spiral face 30c is a cam face for zoom focusing, and the lower spiral face 30d is a cam face for zooming. The journal 30e is inserted into a bearing bore provided in the cam mounting part 27 of the first housing 21. The cylindrical cam 30 is provided with a bearing hole in the upper end part thereof to receive a shaft part formed in the second housing 41 as explained later to support the upper side of the cylindrical cam 30 for rotation. On the cylindrical part 30a of the cylindrical cam 30 is defined a reference line extending in the vertical direction in FIG. 2, although not shown in FIG. 7, the reference line being different, for example, in color from the color of the peripheral surface of the cylindrical part 30a.

Reference numeral 31 and 32 are a first lens assembly and a second lens assembly respectively having moving lenses attached thereto, 33 and 34 are lens holders of the first and second lens assembly respectively. Reference numeral 33a and 33b's are supporting arms of the lens holder 33, the arms 33a and 33b's extending from the periphery of the lens holder 33 radially outwardly, and 33c is a cam follower arm to be brought into contact with the upper spiral cam face 30c, the cam follower arm 33c also extending from the periphery of the lens holder 33 radially outwardly. Reference numeral 34a and 34b's are supporting arms of the lens holder 34, the arms 34a and 34b's extending from the periphery of the lens holder 34 radially outwardly, and 34c is a cam follower arm to be brought into contact with the lower spiral cam face 30d, the cam follower arm 34c also extending from the periphery of the lens holder 34 radially outwardly. Reference numeral 34d's are depressions (second concave portions) formed on the periphery of the lower part of the lens holder 34, which can be recognized clearly in FIG. 9A. By virtue of the depressions 34's, the lens holder 34 can be advanced near to the object side fixed lens without interfered by the protruded portions of the annular formation 22a in FIG. 2. Reference numeral 35 and 36 are moving lens groups retained by the lens holders 33 and 34 respectively, and 37 is a spring member connected to the lens holders 33 and 34 so that the holders pull one another.

The lens holder 33 has a supporting arm 33a and a pair of supporting arms 33b's, each being extending radially outwardly from the periphery thereof in directions substantially opposite to each other. Each of the supporting arms 33b's is provided to be located apart to each other by a certain distance in the direction of the optical axis. The lens holder 34 has a supporting arm 34a and a pair of supporting arms 34b's, each being extending radially outwardly from the periphery thereof in directions substantially opposite to each other. Each of the supporting arms 34b's is provided to be located apart to each other by a certain distance in the direction of the optical axis. Each of the lens holders 33 and 34 is provided with a cam follower arm 33c and 34c extending radially outwardly deviated by an angle θ (see FIG. 9B) from the direction of the pair of supporting arms 33b's and 34b's and adjacent to the pair of supporting arms 33b's and 34b's respectively, the cam follower arm 33c overlapping with the supporting arms 33b's and the cam follower 34c overlapping with one of the supporting arm 34b's at least partially in the direction of the optical axis.

A guide groove is provided in each of the supporting arms 33a and 34a of the lens holders 33 and 34 for fitting slidably to the first shaft (guide shaft) 26a in FIG. 4, and a guide hole is provided in each of the supporting arms 33b's and 34b's for fitting slidably to the second shaft (guide shaft) 26b in FIG. 4. The supporting arms 33b's and 34b's of the lens holders 33 and 34 are formed such that the holders are fitted slidably to the second shaft 26b in a state that one of the supporting arms 33b's and one of the supporting arms 34b's cross each other in the direction of the optical axis, that is, the lower supporting arm of the lens holder 33 is positioned between the upper and lower supporting arms of the lens holder 34. With this composition, the supporting arms 33b's can be formed to be apart by an increased distance to each other and also the supporting arms 34b's can be formed to be apart by an increased distance to each other. Therefore, when forces for moving the lens holders 33 and 34 in the direction of the optical axis are exerted slantwise in relation to the optical axis on the lens holders 33 and 34 from the spiral cam faces 30c and 30d via the cam follower arms 33c and 34c, the lens holders 33 and 34 can be moved smoothly along the guide shaft 26b, for the tilting of the lens holders caused by the gap between the guide shaft 26b and the guide holes of the supporting arms 33b's and 34b's becomes small by virtue of the increased distance between each of the supporting arms 33b's and between each of the supporting arms 34b's. Referring to FIG. 11, FIG. 12, and FIG. 13, reference numeral 38 is a driving motor (stepping motor, for example) composing the lens moving mechanism 13, and 38a is a gear attached to the motor shaft of the driving motor 38. The driving motor 38 is located above the third gear 29c with the gear 38a side down in FIG. 11 so that the gear 38a meshes with the second gear 28b shown in FIG. 8. Reference numeral 39 is a boss provided on a peripheral part of the driving motor 38 for attaching one of branched parts of the flexible band 40. The optical sensor 16 is attached to the other of branched parts of the flexible band 40 to face to the cylindrical cam 30. The flexible band 40 is bent in the direction perpendicular to the optical axis to be extended outward of the second housing 41 to which the driving motor 38 is attached.

Reference numeral 41a is a supporting face for supporting an end of the driving motor 38 to define the vertical position thereof, and 41b is an opening at the supporting face 41a for inserting the gear 38a of the driving motor 38 which meshes with the third gear 29c. Reference numeral 41c is a side wall of the second housing 41. An overhanging section is formed at an upper corner of the side wall 41c, and a shaft part is formed to protrude downward from the overhanging section, reference numeral 41d indicating a lightening hole of the shaft part. The upper side of the cylindrical cam 30 is supported rotatably by this shaft part by fitting the bearing hole provided in the upper part thereof as mentioned before. Reference numeral 41f is an opening for allowing the optical sensor for detecting the reference line on the cylindrical cam to face the cylindrical cam 30, and 42 is a cutout opening part extending vertically on a side wall of the second housing 41 with the upper side thereof open (see FIG. 12, 13, and 14). The side wall of the second housing 41 is thin near the cutout opening part 42, and the width of the cutout opening part 42 is smaller than the diameter of the driving motor 38. Further, the second housing 41 has cutout parts on its side in addition to the opening 41f and cutout opening part 42 to define cutout opening parts 11a and 11b when the second housing 41 is assembled to the first housing 21 as shown in FIG. 2. The depth of the second housing 41 in a plane perpendicular to the center axis of the lens holders 33 and 34 (optical axis) is about the same as the sum of the diameter of the cylindrical cam 30 and the diameter of the driving motor 38. A hatched part 43 in FIG. 13 is a cover plate to cover the portion the flexible band 40 is drawn out of the second housing 41. Reference numeral 44 is a side end face of the second housing 41 to be joined to the side end face 45 of the side wall part 21a of the first housing 21, and 59 is a boss for providing a screw hole corresponding to the bolt hole 46 of the first housing 21 to fix the first housing 21 to the second housing 41 by means of a screw bolt.

FIG. 14 shows a perspective view of the state the second housing is attached to the first housing and moving lens assemblies and driving motor 38 are assembled to the housings. In the drawing, a hatched part indicated by reference numeral 42a is a cover plate covering the cutout opening part 42 for light shielding, a hatched part indicated by reference numeral 42e is a cover plate covering the cutout opening part 11b for light shielding. Reference numeral 48's are reference points for measurement when the CCD 15 shown in FIG. 1 is fixed, and 60a and 60b are image pickup device attaching parts for bonding a board mounted with the CCD 15. Referring to FIG. 15, reference numeral 50 is a portable telephone as an example of portable terminal, 51 is an operating portion, 52 is a display made of liquid crystal for example, 53 is a first case part equipped with the operation portion 51, 54 is a second case part equipped with the display 52, 55 is a hinge mechanism, and 56 is a camera module.

The camera module according to the embodiment is constructed such that; the camera casing 11 is composed of the first housing 21 made of resin such as, for example, polycarbonate containing fluorine, which has increased durability and good sliding property, and the second housing 41; the opening 22 for retaining the object side fixed lens is provided in the base part of the first housing 21 as shown in FIG. 2, FIG. 3, and FIG. 10; the annular formation 22a is formed to extend radially inwardly from the inside surface of the opening 22; and reference surfaces 22b's for defining the position of the object side fixed lens in the direction of the optical axis are established on the upper faces of a plurality of protruded portions of the annular formation 22a protruding radially inwardly. On the other hand, depressions 34d's are formed on the periphery of the lower part of the lens holder 34 retaining the moving lens group 36 so that the lens holder 34 can be advanced into the space surrounded by the annular formation 22a without interfered by the protruded portions, on which the reference surfaces 22b are defined, of the annular formation 22a.

With the configuration, the lens holder 34 which moves with moving lens group 36 retained in it can advance into the space surrounded with the annular formation 22a at the opening 22, and enough moving distance of the lens holder 34 for zooming can be secured in a small space, thus a small camera module with sufficient zoom ratio can be provided.

As shown in FIG. 4, the mounting portion 24 for mounting the lens moving mechanism is formed in the base part of the first housing 21 adjacent to the opening 22, the first and second shaft mounting holes 25a and 25b are provided near the peripheral part of the opening 22 at an angle spacing of about 180° and the third and fourth shaft mounting holes 25c and 25d are provided in the mounting portion 24.

The first to fourth shafts 26a-26d made of stainless steel for example are inserted into the first to fourth holes 25a-25d of the base part of the first housing 21 from upper side as indicated by arrows with broken lines. The cam mounting part (cam bearing part) 27 for mounting the cylindrical cam 30 is formed in the vicinity of the mounting portion 24 of the base part, and a shaft body 28 is formed integrally with the first housing 21 to protrude upward in the mounting portion 24. The first and second shafts 26a and 26b are used as guide shafts for guiding moving lens groups. To the third shaft 26c are fitted rotatably the first gear 29a and the second gear 29b as indicated by one of the arrows with broken lines in FIG. 5.

To the fourth shaft 26d is fitted rotatably the third gear 29c, which meshes with the first gear 29a. Further the fourth gear 29d is fitted rotatably to the shaft body 28 to mesh with the first gear 29a. Thus, the first to fourth gears 29a-29d are put together (see FIG. 6). The fourth gear 29d is the last stage gear to mesh with the gear of the cylindrical cam 30 to transmit rotation force to the cylindrical cam. In the embodiment, the shaft body 28 to which the last stage gear 29d is fitted rotatably is integral with the first housing and accordingly made of the same resin material of the housing.

By making the shafts 26c and 26d, to which the gears 29a-29c for transmitting driving force to drive the last gear 29d which meshes with the gear of the cylindrical cam, of metal, gears 29a-29c can be reduced in size, which contributes to downsizing the camera module and reducing mechanical noise, because the shafts 26c, 26d made of metal can be reduced in their diameters, for the rotation speeds of the gears are high but the loads exerting on the gears are light.

As the shaft body 28 to which the last stage gear 29d is fitted rotatably is formed integrally with the first housing and therefore is made of resin, it is light even if its diameter is increased for securing enough strength. Further, by forming the shaft body integrally with the first housing, the number of parts and assembling man-hours can be reduced.

The bearing part to support the cylindrical cam for defining the movement of the lens holders 33 and 34 is formed in the first housing so that a particular bearing needs not be provided, and the first housing is made of resin containing fluorine so that the bearing part has durability and good sliding property as a bearing. Therefore, as no particular bearing is needed, the number of parts is reduced, downsizing and weight saving of the camera module are possible, and the strength of the housing is increased by adding fluorine to the resin material of the housing.

In the embodiment of the camera module of FIG. 1, the casing 11 is made of, for example, resin such as polycarbonate containing fluorine to increase durability and improve sliding property, the casing being composed of the first housing 21 shown in FIG. 2 to which the driving mechanism 13 is mounted and the second housing 41 to which the motor 38 shown in FIG. 12 is attached; and the board mounted with the CCD 15 for picking up images, optical sensor 16 consisting of a light emitting device and a photoreceptor device, and cover plates (light shielding member) such as indicated by reference numerals 14, 41e are attached to the casing to compose the camera module to be small in size to be used as an image pickup device for the portable telephone 50 shown in FIG. 15 as an example of portable terminals. Shooting and zooming operation of the camera module can be done by manipulating the operating portion 51 shown in FIG. 15.

FIG. 15 is a plan view of the portable telephone 50 shown in a state the operating portion 51 and display 52 are viewable (opened state); the first case 53 equipped with the operating portion 51 and the second case 54 mounted with the display 52 are connected with the hinge mechanism 55, and the first and second case 53, 54 can turn around the hinge mechanism 55.

The camera module is mounted to the second case 54 so that the optical lens system 12 is located at the position indicated by a double circle of broken line in the drawing, photographing is done by the camera module by manipulating a designated button on the operating portion 51, and the photographed image is displayed on the display 52. Therefore, the camera module is required to be composed very small in size. Zooming operation of the camera module can be possible by manipulating another designated button of the operating portion 51.

The embodiment of the camera module has the first housing 21 shown in FIG. 1, FIG. 2, the opening 22 for accommodating the object side fixed lens of the optical lens system 12 being defined in the base part (upper part in FIG. 2) of the first housing 21, the annular formation 22a being formed to extend radially inwardly around the inner surface of the opening 22, the annular formation 22a having a plurality of protrusions protruding radially inwardly-with a reference surface 22a defined on the upper surface of each of the protrusions, between the protrusions being formed concaved portions 22d for allowing the lens holder 34 to advance to the annular formation 22a. Salient parts 22c's for defining the center position of the object side fixed lens of the optical lens system 12 are provided on the inner surface of the opening 22 to extend from the reference surfaces 22b's. The position in the direction of the optical axis of the fixed lens is determine by the reference surfaces 22b's and central position thereof is determined by the salient parts 22c's accurately.

The first housing 21 has the base part having the reference surfaces 22b's for mounting the object side fixed lens of the optical lens system 12 thereon and reference surfaces 23's which serve as reference surfaces when the lens assemblies, lens moving mechanism are assembled automatically onto the base part, the lens assemblies 31, 32 comprising the lens holders 33, 34 and the lens moving mechanism comprising the cylindrical cam 30 and gears 29a-29d being able to be assembled onto the base part from the open side opposite to the base part of the first housing. Therefore, moving lens groups and lens moving mechanism can be incorporated and adjusted with ease and automatic assembling with good accuracy can be made possible. Further, the first housing 21 can be removed from the mold in a direction with the accuracy of the reference surfaces side secured when casting.

The first housing 21 has the first side wall part 21a and second side wall part 21b continuing to the base part, the portions other than the side walls being cutout opening parts, and on the upper face of the base part are formed a plurality of protrusions on which the reference surfaces 23's are provided (three reference surfaces in the case of example in FIG. 2). These reference surfaces 23's are brought into contact with the reference surface of an assembly jig (not shown in the drawings) when the camera module is automatically assembled with the base part side of the first housing 21 down to serve as reference surfaces for securing accuracy in assembling and adjusting the lens assembly and lens moving mechanism.

The cylindrical cam 30 is a cam member of nearly cylindrical shape made of metal, resin, or resin containing fluorine and has the cylindrical part 30a and spiral formation 30b defined on the periphery of the cylindrical part 30a. On the spiral formation 30b are defined the zoom focusing face 30c on the upper side thereof in FIG. 7 and zooming face 30d on the lower side thereof in FIG. 7. In the case the cylindrical cam 30 is made of resin, it can be made to have lightweight, strength, and durability, and further in the case it is made of resin containing fluorine, the sliding property of the journal 30e can be improved. The optical lens system of the camera module of the embodiment is an example of a dual focus type, the zooming face 30d is defined such that the second lens assembly 32 for shifting focus point is moved by a predetermined distance by the rotation of the cylindrical cam and after that the lens assembly 32 is not moved by further rotation of the cylindrical cam 30. The zoom focusing face 30c is defined such that the first lens assembly 31 is moved for focusing by the rotation of the cylindrical cam 30 even after the second lens assembly 32 is stopped after it is moved by the predetermined distance.

When the cylindrical cam 30 and the first and second lens assemblies are assembled to the first housing 21, the lower end face of the cam follower arm 33c contacts the focusing face 30c and the upper end face of the cam follower arm 34c contacts the zooming face 30d. The lens holders 33, 34 are connected by means of the spring 37 to be pulling each other. A reference line, although not shown in the drawings, extending in the axial direction of the cylindrical 30 is provided on the cylindrical part 30a thereof, the reference line being different, for example, in color from that of the cylindrical part 30a so that the line is detected by the optical sensor 16 shown in FIG. 16 detects the original position of the cylindrical cam 30.

As shown in FIG. 8, when the lens-assemblies 31, 32 and cylindrical cam 30 are assembled to the first housing 21, the second lens assembly 32 and first lens assembly 31 are mounted from the upper side of the first housing 21 so that the supporting arm 34a and 33a are fitted slidably to the first shaft 26a and the supporting arms 34b's and 33b's are fitted slidably to the second shaft 26b in the state the upper arm of the arms 34b's is located between the arms 33b's, then the cylindrical cam is mounted from the upper side of the first housing through inserting the journal 30e of the cylindrical cam 30 into the bearing bore of the cam mounting part 27 (see FIG. 4) provided at a peripheral part of the base part of the first housing 21 so that the upper contact face of the cam follower arm 34c contacts the zooming face 30d and the lower contact face of the cam follower arm 33c contacts the zoom focusing face 30c. With this construction, the contact positions of the cam follower arms 33c and 34c with the zoom focusing face 30c and zooming face 30d of the spiral formation 30b move along the faces 30c and 30d respectively as the cylindrical cam rotates, and the first and second lens assemblies can be moved smoothly in the direction of the optical axis guided by the first and second shafts 26a and 26b.

As the lens holder 34 is provided with the depressions 34d's as shown in FIG. 9 and FIG. 10 so that it can advance into the space surrounded by the annular formation 22a without interfered by the protrusions (on which are defined the reference surfaces 22b's) of the annular formation 22a in the opening 22 shown in FIG. 3, the lens holder 34 can be moved near to the fixed lens retained in the opening 22. Therefore, a camera module can be provided which has zoom ratio large enough by securing enough moving distance of the lens holder 34. As the cutout opening part 11a is provided in the casing 11 as shown in FIG. 1, lens moving mechanism 13 such as lens holders 33, 34, and cylindrical cam 30 are accessible from outside before the opening part is covered, it is possible to perform visual inspection, a variety of adjustment, and accuracy confirmation of the optical system.

The driving motor (stepping motor, for example) 38 composing the lens moving mechanism 13 having the gear 38a attached to the motor shaft thereof is supported on the supporting face 41a of the second housing 41 with the gear-side down and the gear 38a inserted into the opening 41a as shown in FIG. 11. In this state, the gear 38a is located above the third gear 29c and meshes with the gear 29b shown in FIG. 8. Further, one of the branched parts of the flexible band 40 is attached to the boss 39 provided on a peripheral part of the driving motor 38, and the flexible band 40 is extended out of the second housing 41.

In one of the side wall 41c of the second housing 41 is defined the opening 41f, at which the other of the branched parts of the flexible band 40 mounted with the optical sensor 16 is attached. The optical sensor 16 detects the reference line on the cylindrical part 30a of the cylindrical cam 30 to determine the original position of the cylindrical cam 30 or rotation angle position or angles rotated. The flexible band having the optical sensor 16 mounted thereto serves also for covering the opening 41f. With the construction like this, the motor 38 is mounted at the opening 42 and the sensor 16 is mounted at the opening 41f without reducing the strength of the second housing, and a camera module can be constructed to be small in size and light in weight, and to have enough strength, and a portable terminal equipped with the camera module can be provided.

The driving motor 38 is attached to the second housing 41 of the casing 11 as shown in FIG. 12. The cutout opening 42 is defined in a side wall of the second housing 41 to extend in the vertical direction to be upwardly open. Further, the side wall is thin near the cutout opening 42 of the second housing 41, and the width of the cutout opening is smaller than the diameter of the driving motor 38. The depth of the second housing in the plane perpendicular to the direction of the optical direction of the lens holders 33, 34 is about the same as the sum of the diameter of the cylindrical cam and the diameter of the driving motor 38. Therefore, the driving motor 38 and the cylindrical cam 30 can be located to be adjacent to each other in the direction of the depth.

In FIG. 12, 13, each of the inside surface of both sides of the vertically extending cutout opening 42 is formed into the surface of a segment of a cylinder so that the peripheral surface of the driving motor 38 contacts the surfaces of the cylindrical segments tight fittingly in the state the driving motor 38 is supported on the supporting face 41a. Therefore, by applying an adhesive agent to the surfaces of the cylindrical segments as shown by hatching in FIG. 12 and locating the driving motor 38, the same is adhered and fixed to the second housing 41 firmly. The flexible band 40 is drawn out of the second housing 41 from the upper part of the housing as shown in FIG. 13. The part where the flexible band 40 is drawn out is covered by the cover plate 43 indicated by hatching in FIG. 13. The cutout opening part 42 is covered by the light shielding cover plate 42a (see FIG. 14).

In some cases, the diameter of such a very small motor may be smaller than 5 mm, and it is difficult to attach the motor in such a way as to provide screw holes on the end face of the output shaft side of the motor to fix the motor in the camera module. Therefore, it is a most common way to wind a ring plate around the periphery of the motor and fix the ring plate to the case of the camera module. However, it is difficult to fix the motor in position with good accuracy in position and inclination by such a way. Therefore, as a method of attaching the drive motor in the camera module like this, said method has a problem in accuracy point of view.

However, by fixing the driving motor in this way, the driving motor 38 is bonded and fixed to the surfaces of the cylindrical segment defined inside both sides of the vertically extending cutout opening part 42 tight fittingly with good accuracy. Therefore, the driving motor can be fixed easily and simply to the housing with good accuracy without necessity of using fastening screws or ring plate as has been the case with prior arts.

In the embodiment, the motor 38 and cylindrical cam 30 are juxtaposed to each other and in the vicinity of the moving lens holders 33, 34 of the optical lens system 12 and the center axis of the cylindrical cam 30 is parallel to the optical axis of the lens system 12 as recognized from FIG. 14, so that the optical lens system 12, motor 38, and cylindrical cam 30 can be incorporated with ease. In addition, as the depth of the second housing 41 in the plane perpendicular to the direction of the optical direction of the lens holders 33, 34 is about the same as the sum of the diameter of the cylindrical cam and the diameter of the driving motor 38, a downsized camera module can be provided.

The first housing 21 mounted with the lens system and driving mechanism is joined to the second housing 41 to which the driving motor is fixed such that; a corner part of the base part of the first housing 21 where the bolt hole 46 is provided mates to the boss part 59 of the second housing 41, the lower end face of the side wall part 41c (see FIG. 11) of the second housing 41 mates to the upper end face of the side wall part 21b (see FIG. 5, 6, and 8) of the first housing 21, and the side end face 44 (see FIG. 11) of the second housing 41 mates to the side end face 45 (see FIG. 5, 6, and 8) of the first housing 21. That is, an adhesive agent is applied onto the adhesive-joining part 47 of the first housing 21, a bolt (not shown in the drawings) is let in through the bolt hole indicated by reference numeral 46 in FIG. 4, the side end face 44 (see FIG. 11) of the second housing 41 with the driving motor fixed thereto mates to the side end face 45 (see FIG. 5, 6, 8) of the first housing 21, and the second housing is fixed to the first housing with the bolt and the adhesive agent while preventing deviation of the housings relative to each other in rotational direction around the fixing part 46 to be fixed by the bolt.

When the first housing 21 and second housing 41 are joined together and fixed in this way, a board mounted with the CCD indicated by reference numeral 15 is adhered to the image pickup device attaching parts 60a and 60b of the first and second housing. The attaching of the board mounted with the CCD 15 is performed in such a way that; the board mounted with the CCD 15 is moved around 5 axes, taking for example three points indicated by reference numerals 48's as the basis for the movement while picking up an image sent through the optical system 12, a position of the board is detected with which the optical axis of the CCD 15 and that of the optical lens system 12 coincide and at the same time the image is optimally focused into the CCD 15, the board is retained in the position, and an adhesive agent is inpoured to the concave 58. In this way, the board mounted with the CCD 15 is bonded and fixed to the casing 11.

After the board mounted with the CCD 15 is fixed to the casing 11, the cover plate (light shielding member) indicated by reference numeral 14 in FIG. 1 is attached by means of an adhesive agent to the casing 11 to cover the cutout opening defined by the first housing 21 and second housing 41, and the cutout opening part indicated by reference numeral 42 at the attaching part of the driving motor 38 and other cutout opening parts are covered similarly with cover plates (light shielding members) to bring the camera module of the embodiment shown in FIG. 1 to completion.

Although the casing 11 of the camera module of the embodiment has the cutout opening parts 11a, 11b shown in FIG. 12, the opening 41f shown in FIG. 12, and the cutout opening part 42, each of the opening parts is covered with the cover plate 14 which covers the opening part 11a, with the flexible band mounted with the optical sensor 16 which covers the opening 41f, with the cover plate 41e which covers the opening part 11b, and with the cover plate 42a which covers the opening part 42. As the cover plate 14 covers the opening part between the first thick side wall part 21a and the second thick side wall part 21b, the cover plate 41e covers the opening part of the second housing 41 in the state the cover is bent at right angles to form a corner part, the opening 42 is relatively narrow in width, shut up by the motor 38 and covered with the cover plate 42a, and the opening 41f is relatively small and covered with the flexible band, the casing 11 is made strong enough by the presence of those covers. Further, as the cylindrical cam 30 and the lens moving mechanism including lens holders 33, 34, etc. can be accessed through the opening 11a before the cover plate 14 is attached, it is possible to perform visual inspection, a variety of adjustment, and accuracy confirmation of the optical system when assembling the camera module. Further, the sliding condition of the lens holders 33, 34 can be confirmed from the opening 11b, and the opening 42 is used for attaching the driving motor 38 as mentioned before. Thus, these opening parts are used effectively and serves to reduce the weight of the camera module.

In the camera module of the embodiment constructed like this, when the driving motor 38 shown in FIG. 11 rotates, the rotation force is transmitted from the gear 38 to the cylindrical cam via the gears 29a-29d shown in FIG. 8. The cam follower arms 33c and 34c of the first and second lens assembly 31 and 32 are moved in the direction of the optical axis by the rotation of the spiral formation 30b of the cylindrical cam 30, and zooming and focusing can be done smoothly as mentioned before. The original position of the cylindrical cam 30 can be determined through detecting the reference line on the cylindrical part 30a by the optical sensor 16, and focus distance and focus position can be obtained by counting the number of pulses given to the driving motor such as a pulse motor.

As has been described in the foregoing, according to the embodiment, by providing concaved portions in the retaining portion for retaining one of the lenses of the optical lens system to allow a lens holder to advance to the retaining portion, a camera module can be provided which is small in size, light in weight, and composed such that lens moving distance of enough length can be secured even if autofocusing function and zooming function are incorporated.

In a camera module like this, lenses, a lens moving mechanism such as a cam and motor for autofocusing or zooming, gears, etc. are desirable to be composed of as small number of parts as possible, material of the parts should be carefully selected to achieve long operation life. Also, the order and direction of assembling component parts must be taken into consideration for automatic assembling in order to save man-hours. Further, the casing of simple structure is desired for the camera module for cost reduction.

In the case the driving mechanism and driving source for moving lenses and gears for transmitting the driving force of the driving source to the driving mechanism are incorporated in the camera module, the casing of the camera module must be composed to be strong enough to retain them positively, and normal photographic image can not be obtained if the camera module is not perfectly shielded from intrusion of light.

However, in the camera module of the embodiment, as the shaft made of resin is molded in one piece with the housing as has been mentioned in the forgoing, the number of constituent parts is reduced and man-hours to attach the shaft are eliminated. Further, as fluorine is contained in the material of the housing, the housing can be produced to have enough strength.

Further, as the reference points (surfaces) 23's are provided on the basis of the reference surfaces 22b's for retaining the fixed lens, and the lens assemblies comprising the holders 33, 34, and the lens moving mechanism comprising the cylindrical cam 30 and gears 29a˜29d can be assembled from opened side of the housing, the assembling and adjusting of the optical lens system 12 and the lens moving mechanism can be performed with ease and they can be automated retaining good accuracy. Further, when molding, the first housing 21 can be drawn out of the mold in one direction with accuracy secured in the side where both reference surfaces are formed and the housing can be produced at a low cost.

Further, as the annular formation, on which reference surfaces 22b's for determining the position of the object side fixed lens in the optical axis are defined, is formed in the opening for attaching the object side fixed lens of the first housing 21, and at least three salient parts are provided on the inside surface of the opening for attaching the fixed lens above the annular formation such that the periphery of the lens contacts the salient parts, the fixed lens can be positioned accurately in relation to the direction of the optical axis.

Further, as the driving motor 38 is fixed to the second housing adjacent the cylindrical cam 30, and the depth of the second housing in a plane perpendicular to the optical axis of lens system is about the same as the sum of the diameter of the cylindrical cam 30 and the diameter of the driving motor 38, the camera module can be constructed to be small in size.

Further, as the cylindrical surface to which the driving motor 38 is bonded with its periphery is formed such that the cutout opening part 42 is formed and the side wall becomes thin near the opening part, and the opening part is covered with the light shielding member 42a, the motor attaching part of the second housing can be formed to be thin-walled and the camera module can be constructed to be very small in size.

The width of the cutout opening part 42 is smaller than the diameter of the driving motor 38, and each of the inside surface of both sides of the opening part 42 is formed into the surface of a segment of a cylinder so that the peripheral surface of the driving motor 38 closely contacts the surfaces of the cylindrical segments, the motor can be fixed to the second housing with good accuracy.

As rotation speeds of the gears fitted rotatably to the metal shafts 26c, 26d are high but loads are light, shafts of small diameter can be adopted for metal shafts of 26c, 26d, as a result the gears can be small sized, the apparatus (camera module) can be produced to be small in size, and mechanical noise can be reduced. As the rotation speed of the last stage gear 29d fitted rotatably to the shaft 28 made of resin is low, noise emission due to the rotation is minimal, and as the shaft 28 is made of resin material, the shaft is light in weight even when the diameter is increased to secure strength. Further, by molding the resin shaft in one piece with the housing, the number of constituent parts is reduced and man-hours to attach the shaft are eliminated.

Further, as the casing 11 of the camera module is made of resin containing fluorine, durability and sliding property is increased, and if a shaft and bearing are formed in one piece with the housing, they have high durability and the gear fitted rotatably to the shaft can rotate smoothly. Further, by adopting resin material containing fluorine not a simple resin for the casing, the casing can be increased in strength, as a result the casing can be formed thinner, and downsizing and weight saving of the camera module can be realized.

Further, by making the cylindrical cam 30 of resin, or resin containing fluorine, the cam is reduced in weight as compared to the case the cam is made of metal, and by adding fluorine to the resin material, the strength and durability of the cam is increased and the sliding property of the journal 30e which rotates in the bearing is improved.

Further, the lens holders 33, 34 retaining the moving lenses are formed such that; the cam follower arms 33c, 34c which contact the upper and lower cam faces of the spiral formation of the cylindrical cam respectively, and the supporting arms 33a, 33b's, 34a, and 34b's each having a groove or hole to be fitted slidably to the guide shafts 26a, 26b to be guided in the direction of the optical axis, are formed integrally with the lens holders 33, 34 respectively to extend radially from the peripheral part of each of the lens holders 33, 34, the supporting arms 33a and 34a extending in substantially opposite direction to the arms 33b's and 34b's respectively, the arms 33b's and 34b's forming a pair of arms respectively, the pair of arms 33b's and the pair of arms 34b's extending in the direction different by a certain angles θ to the direction of the cam follower arms 33c and 34c respectively, and the pairs of the arms 33b's, 34b's are fitted slidably to one of the guide shafts so that one of the pair of the arms 33b and one of the pair of the arms 34b are fitted slidably to the guide shafts to cross each other in the direction of the optical axis, so that the distance between both arms of the pair of arms can be increased in a narrow space. This allows the camera module to be constructed small in size and effects to reduce the slant of the lens holders 33, 34 when the forces to move the lens holders 33, 34 exert slanted to the direction of the optical axis.

As has been described in the foregoing, according to the embodiment, a camera module having autofocusing and zooming functions and most suitable to incorporate in a portable terminal, etc. can be provided, and a user-friendly portable terminal equipped with the camera module can be provided.

1. A camera module comprising accommodated in the casing thereof an optical lens system, a lens moving mechanism for moving a plurality of lenses of the optical lens system in a predetermined direction to perform focal adjustment and/or change of image magnification, and a housing composing a casing of the camera module,
a lens retaining part formed in said housing for retaining one of the lenses of the optical lens system,
lens holders for accommodating said moving lenses,
protruded portions provided in said lens retaining part for contacting said one of the lenses at least at three points to determine the position of said one of the lenses, and
concaved portions provided in said protruded portions such that the peripheral part of said one of the lenses is exposed,
whereby at least one of said lens holders can advance to said concaved portions provided in said protruded portions.

2. The camera module according to claim 1, wherein said at least one of lens holders has depressions (second concaved portions) to correspond to said protruded portions in said lens retaining part.

3. The camera module according to claim 2, wherein said lens moving mechanism includes a cylindrical cam located in the vicinity of the periphery of said lens holders, a cam bearing part for supporting said cylindrical cam, guide shafts for guiding said lens holders, and guide shaft attaching parts for attaching said guide shafts, and wherein said guide shaft attaching parts and said cam bearing part are formed in one piece with said housing.

4. The camera module according to claim 3, wherein each of said lens holders has supporting arms extending radially outwardly to be fitted slidably to said guide shafts and a cam follower arm extending radially outwardly in different directions, the arms being formed in one piece with the lens holder, and wherein said cam follower arm extends radially outwardly such that the cam follower arm overlaps in the direction of the optical axis at least partially with at least one of supporting arms or arms extending in radial outward direction.

5. The camera module according to claim 3, wherein said lens moving mechanism includes at least a gear group fitted rotatably to shafts to transmit the driving force of the driving source to said cylindrical cam, and wherein at least a shaft to which the last gear among said gear group is fitted rotatably (last stage gear shaft) is made of resin and other shafts are made of metal.

6. The camera module according to claim 4, wherein said supporting arms and cam follower arm are formed in one piece with said lens holder.

7. The camera module according to claim 5, wherein said last stage gear shaft is formed in one piece with said housing.

8. The camera module according to claim 5, wherein a positioning part is provided in said housing for locating said driving source to be fixed there, the positioning part having an opening part.

9. The camera module according to claim 5, wherein said gear group is arranged in the space near toward the part where said one of the lenses is located between said cylindrical cam and said driving source.

10. The camera module according to claim 5, wherein said housing is made of resin containing fluorine.

11. The camera module according to claim 5, wherein said cylindrical cam is made of resin.

12. A portable terminal having a camera module which comprises:
a housing accommodating an optical lens system, a lens moving mechanism for moving at least some of the lenses of the lens system, and an image pickup device and composing the casing of a camera module,
a lens retaining part formed integrally in the housing for retaining one of the lenses of the lens system,
a attaching part provided in said housing for attaching said image pickup device,
lens holders for retaining the lenses composing said optical lens system,
protruded portions provided in said lens retaining part for contacting said one of the lenses at least at three points to determine the position of said one of the lenses,
concaved portions provided in said protruded portions such that the peripheral part of said one of the lenses is exposed,
guide shafts for guiding said lens holders,
supporting arms provided to each of said lens holders for fitting rotatably to said guide shafts,
a cam follower arm provided to each of said lens holders,
a cylindrical cam contacting to said cam follower arms to allow the lens holders to be moved, whereby one of said lens holders can advance to said concaved portions provided in said protruded portions, wherein at least one of said supporting arms and said cam follower arm extend radially in different directions different by a certain angles from each other, and wherein said cam follower arm overlaps with said at least one of the supporting arms in the direction of the optical axis;
a case body equipped with the camera module; and
an operating portion provided to said case body to operate said camera module mounted to said case body.
